(19) United States
(12) Patent Application Publication
(10) Pub. No.: US 2008/0117751 A1
(43) Pub. Date: May 22, 2008

(54) Jukebox disc deterioration testing

(76) Inventor: Christopher J. Read, San Diego, CA (US)

Correspondence Address: MAYER & WILLIAMS PC, 251 NORTH AVE. WEST, 2ND FLOOR, WESTFIELD, NJ, 07090, US

(21) Appl. No.: 11/603,713

(22) Filed: Nov. 22, 2006

(51) Int. Cl. G11B 5/09

(52) U.S. Cl. 369/47.14

(57) ABSTRACT

An arrangement is provided in which the health of a storage medium such as an optical disc is monitored by analyzing the level of error correction that must be applied to correct read errors from the optical disc. A replacement of the storage medium is generated through a copying process when the error level meets or exceeds a replacement threshold. Once the replacement medium is successfully generated, the digital rights management (“DRM”) license (that may be required to render or play the content from the storage medium) and/or the content contained on the storage medium is overwritten or erased.

### BACKGROUND

Optical recording media such as compact discs (“CDs”) and digital versatile discs (“DVDs”) are commonly used to store digital content such as music, video, games, computer applications and data. Such optical discs can be arranged in pre-recorded form in which data is stored as a series of tiny indentations called pits that are configured in a tightly packed spiral track that is molded into a layer of polycarbonate plastic or alloy forming a portion of the optical disc. Blank recordable optical discs are also available in which the optical discs are manufactured with a blank data spiral. A photosensitive dye or metallic alloy is then applied and the optical discs are typically metallized and coated with a protective finish or layer. A write laser in an optical drive changes the reflectivity in the dye or alloy to thereby enable data to be encoded into the recordable optical disc.

Error correcting codes are typically utilized when reading data from optical discs. For example, Reed-Solomon coding uses an oversampling technique in which a polynomial derived from the data is evaluated at several points and the resulting values are recorded. By sampling the polynomial more often than is necessary, the polynomial is overdetermined. So long as a sufficient number of points of the polynomial can be successfully reconstructed by the optical disc reader, the reader can recover the original polynomial even in the event that some bad (i.e., errored) points exist. CDs commonly use several layers of Reed-Solomon coding and DVDs use similar schemes. Such error correction coding schemes may also employ forward error correction where redundant data is encoded on the optical disc which enables the reader to correct errors without needing to re-read the data from the optical disc.

While optical recording media have successfully demonstrated high storage densities in a cost-effective manner, the lifespan of optical discs does not always meet the expectations of consumers, particularly in stressful environments having high heat and/or humidity. Data loss resulting from the physical deterioration of optical discs is not uncommon, unfortunately. For example, a consumer may store a CD or DVD in the glove compartment of an automobile and then later find that the number of read errors on the disc renders it unsatisfactory or completely unusable.

### SUMMARY

An arrangement is provided in which the health of a storage medium such as an optical disc is monitored by analyzing the level of error correction that must be applied to correct read errors from the optical disc. A replacement of the storage medium is generated through a copying process when the error level meets or exceeds a replacement threshold. Once the replacement medium is successfully generated, the digital rights management (“DRM”) license (that may be required to render or play the content from the storage medium) and/or the content contained on the storage medium is overwritten or erased.

In an illustrative example, a jukebox periodically checks the health of all optical discs that it holds in its custody. When the error correction level of a particular optical disc reaches a threshold that indicates it has deteriorated beyond an acceptable level, the jukebox makes a recommendation to a user that a replacement disc be generated. The user is prompted to insert a blank recordable optical disc into the jukebox which then copies the data from the deteriorated optical disc to the blank recordable optical disc. Once successfully copied, the DRM license and/or content on the deteriorated disk is overwritten or erased to thereby maintain the applicable DRM rights by binding the DRM license solely to the replacement optical disc. The replacement optical disc is released to the user who then is free to use and enjoy the replacement optical disc just as if it were a new original.

In another illustrative example, the jukebox is arranged to maintain statistical health data for each of the optical discs held in its custody. Such statistical health data is utilized to make predictions as to failure or deterioration beyond a recoverable point based on trend analysis for each optical disc. The replacement threshold is arranged to be specific to each particular disc technology utilized. Accordingly, replacement discs can be recommended and generated before the disc becomes unreadable and/or unrecoverable.

A disc replacement service is also disclosed in which certified replacement optical discs (i.e., those sanctioned by the content copyright owner or DRM license issuer) are generated for deteriorated or lost pre-recorded optical discs.

The present jukebox disc deterioration testing arrangement advantageously provides a cost effective and convenient remedy to the problem of shortened lifetime of optical discs. In addition, since it relies on custody of media content as an enabler of usage rights, the expectations of consumers—who traditionally equate possession of an object with the right to use it—are better satisfied.

### BRIEF DESCRIPTION OF THE DRAWINGS

FIG. 1 is a pictorial view of an illustrative jukebox disc deterioration testing arrangement showing a jukebox with two optical disc drives;

FIG. 2 is a pictorial view of an illustrative jukebox disc deterioration testing arrangement showing a jukebox having two optical disc drives, two removable media drives, and a carousel storage system;

FIG. 3 is a pictorial view of an illustrative jukebox disc deterioration testing arrangement showing a tower-type media server or PC with monitor and keyboard;

FIG. 4 is a functional block diagram of an illustrative media server employing the principles of the invention;

FIG. 5 is a flowchart of an illustrative method for performing jukebox disc deterioration testing; and

FIG. 6 is a flowchart of an illustrative method for providing certified copies of pre-recorded discs.

### DETAILED DESCRIPTION

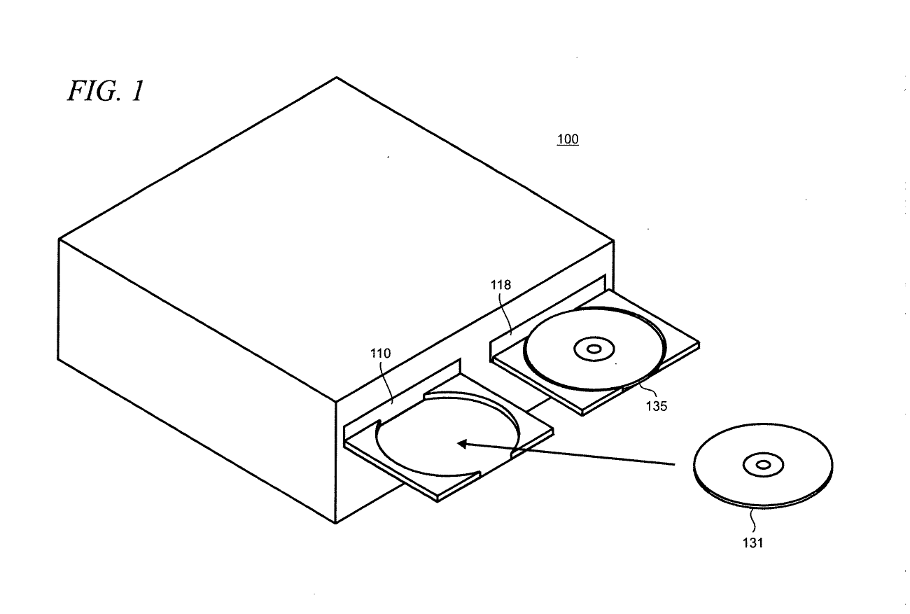

FIG. 1 is a pictorial view of an illustrative jukebox disc deterioration testing arrangement showing a jukebox 100 with two optical disc drives 110 and 118, respectively. Jukebox 100 has custody of media content 131. Media content 131 is shown in FIG. 1 as stored using an optical disc storage medium such as a CD or DVD. Alternative optical storage formats include HD-DVD, Blu-Ray, hybrid DVD, Enhanced Versatile Disc, and optical holographic disc.

Custody of the media content is a fundamental principle which underlies the DRM license archival paradigm which grants rights to the holder of the medium and associated DRM licenses that are bound to it in accordance with the present invention. That is, under the paradigm, custody of the media content is required to enable usage rights according to the associated DRM licenses. Without custody, no rights under the DRM licenses are provided.

A recordable medium 135 such as a CD-R, DVD+R, Blu-ray disc, writable high-definition DVD or other type of writable optical disc is shown in optical drive 118. Accordingly, optical drive 110 is commonly referred to as a source drive while optical drive 118 is referred to as a target drive. It is noted that many optical drive arrangements are enabled with both read and write capabilities so the selection of one drive to be the source drive and the other to be the target drive is arbitrary.

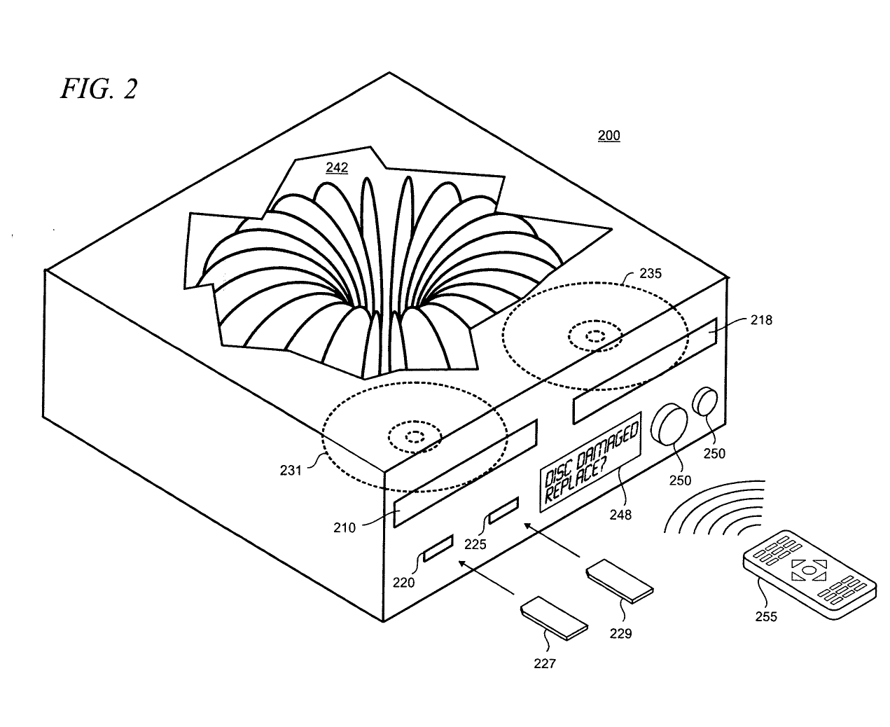

FIG. 2 is a pictorial view of an illustrative jukebox disc deterioration testing arrangement showing a jukebox 200 having a source optical disc drive 210 and target optical disc drive 218 which hold source optical disc 231 and target optical disc 235, respectively. Jukebox 200 further includes two removable media drives arranged as source removable media drive 220 and target removable media drive 225.

Removable media drives 220 and 225 are arranged to read from and write to removable storage media 227 and 229, respectively. Removable storage media 227 and 229 are utilizable as alternative media content containers and are typically selected from one or more of the variety of currently available flash memory cards such as Memory Stick, CompactFlash and SD (Secure Digital) cards. Such flash memory cards are small but are capable of storing large amounts of digital media content, often in the multiple gigabyte range.

In this illustrative example, additional media content 242 in the form of optical discs is held in a carousel arrangement in jukebox 200 as shown in cutaway view in FIG. 2. However, any of a variety of different storage formats, holding arrangements, and number of discrete media is also usable depending on the requirements of a specific application.

Media server 200 includes a visual display 248 and controls 250 that may be employed by a user to effectuate selection and control of various operating features of media server 200. Alternatively, a remote control device 255 is commonly utilized to provide additional selection and control features. In alternative arrangements, media server 200 is configured with interfaces (not shown) to an external input device such as a keyboard, and/or an external display device such as a monitor.

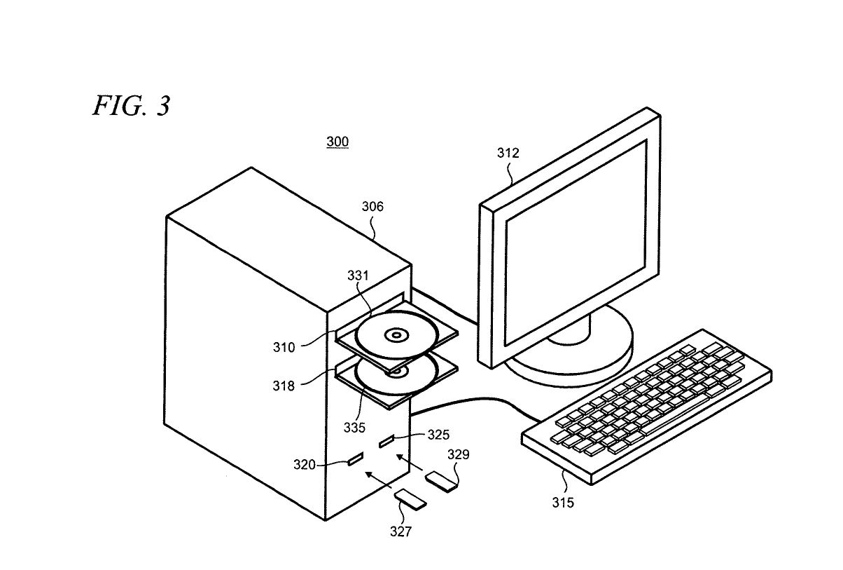

FIG. 3 is a pictorial view of an illustrative jukebox disc deterioration testing arrangement showing a tower-type media server or PC 300 with monitor 312 and keyboard 315. PC 300 is configured with dual optical drives 310 and 318 which respectively hold custody of the source media content disc 331 and the target recordable optical disc 335. PC 300 is further equipped with dual removable media drives 320 and 325 that interface with removable storage media 327 and 329, respectively.

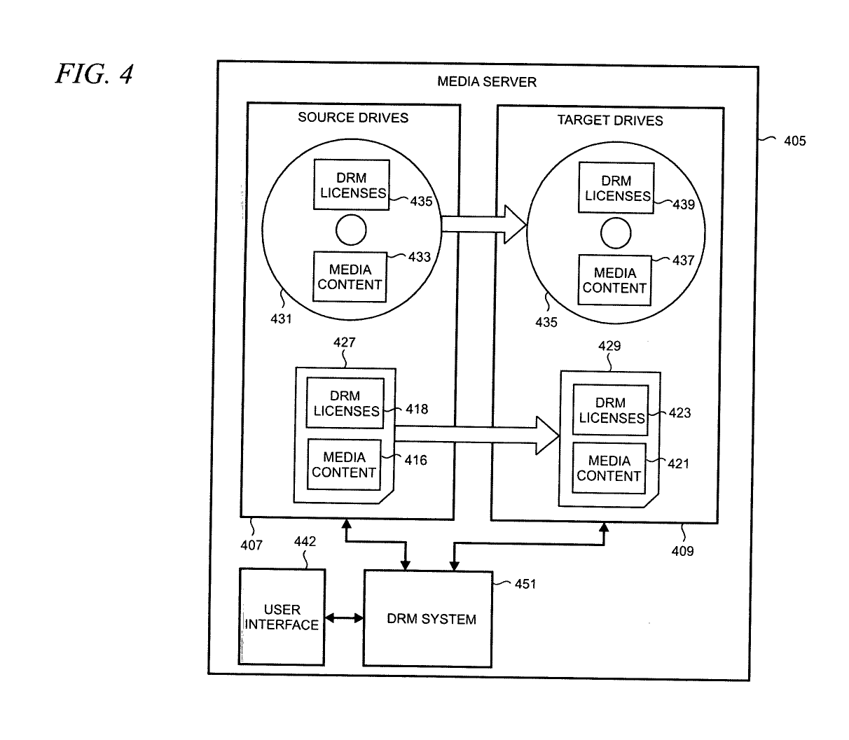

Each of the arrangements shown in FIGS. 1-3 and described in the accompanying text are examples of electronic devices that may be configured to perform jukebox disc deterioration testing in accordance with the principles of the invention. Typically, each such arrangement will include the functionalities shown in FIG. 4 and described below.

FIG. 4 is a functional block diagram of an illustrative media server 405 employing the principles of the invention to perform jukebox disc deterioration testing. While an illustrative media server is shown and described, it is emphasized that the principles of its operation may also be readily incorporated into a jukebox, PC, server or other electronic device to thereby realize the benefits described herein.

In this illustrative example, media server 405 includes a set of source drives 407 and a set of target drives 409. That is, both optical drives and removable media drives are provided. Source drives 407 hold custody of source removable media 427 and source optical disc 431. Source removable media 427 contains media content 416 and associated DRM licenses 418. Similarly, source optical disc 431 contains media content 433 and associated DRM licenses 435, as shown.

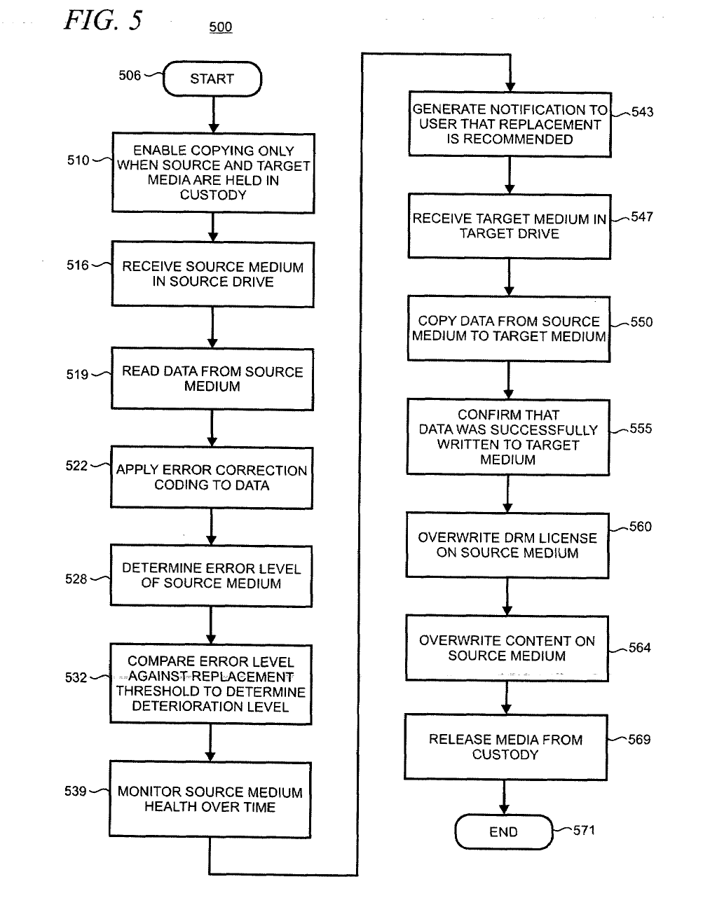

A DRM system 451 is operatively coupled to source drives 407 and target drives 409. DRM system 451 is arranged to control the reading and writing of data to and from the drives responsively to the disc deterioration testing methodologies described in more detail below in the text accompanying FIG. 5.

Target drives 409 hold custody of target removable media 429 and target optical disc 435. If, upon completion of the jukebox disc deterioration testing, the generation of a replacement medium is appropriate, then the target removable media 429 will contain media content 421 copied from media content 416 from the source removable media 427 and DRM licenses 423 copied from DRM licenses 418 on the source removable media 427. Similarly, the target optical disc will contain media content 437 copied from media content 433 on source optical disc 431 and DRM licenses 439 copied from DRM licenses 435 on source optical disc 431.

Media server 405 is configured with a user interface 442 as shown in FIG. 4. User interface 442 is operatively coupled to DRM system 451 to enable user control over the jukebox disc deterioration testing and replacement medium generation. However, it is emphasized that in most applications it is desirable for the process to be as transparent to the user as possible. Thus, for example, user interface 442 may be arranged to provide the user with a prompt to insert an optical disc into the optical disc drive to enable the transfer of the media content and associated DRM licenses from the source disc to the target disc when the media server 405 detects that the source disc has reached or exceeded a replacement threshold for errors.

Turning now to FIG. 5, an illustrative method 500 is shown for performing jukebox disc deterioration testing. The illustrative method 500 is intended to be performed by any of arrangements shown in FIGS. 1-4. The illustrative method 500 starts at block 506. At block 510, in accordance with the principles of the present jukebox disc deterioration testing arrangement, copying of media content contained on a source medium is enabled only when the source medium and a target medium are held in custody of a media server. In this way, copying can be controlled to ensure that DRM protection is locked to the target medium, and further, that the source medium is overwritten to prevent proliferation of copies of the media content in violation of the DRM licenses.

At block 516, a source medium such as an optical disc or removable medium is inserted into the source drive of the media server. The media server then reads the data from the source medium at block 519. Error correction coding is utilized at block 522 in the illustrative process, for example, Reed-Solomon coding and/or forward error correction coding to thereby correct for any read errors from the source medium.

At block 528, the number of errors that are corrected are counted and tracked to thereby establish a quantitative error level for a particular source medium. Such error tracking may be alternatively performed on a block, track, or disc basis as required by a specific application of the invention.

At block 532, the error level is compared against a threshold that, when exceeded, indicates a sufficient level of deterioration of the source medium has occurred to warrant replacement of the source medium. The threshold is contemplated as being different for different storage media types, as the number and distribution of various errors can have different effects on the readability depending on which storage medium type is utilized for a particular source. For example, dye-type recordable optical media could have a different replacement threshold than metal-type or pre-recorded (i.e., pressed pit) media types. Various optimizations may be required to set a particular replacement threshold for particular media type where such optimizations are preferably determined empirically using statistical analysis.

Block 539 indicates an optional step whereby the health (i.e., the error level which is indicative of a level of deterioration) of the source medium is monitored over some time interval. This is accomplished by periodically and iteratively performing the method steps indicated by blocks 519, 522, 528 and 532 as described above. Such source medium health monitoring data may be stored to thereby create a statistical database for each of the one or more discs that the media server may hold in custody. Such statistical data may be employed, for example, to perform trend analysis to enable some prediction of future failure (i.e., unrecoverable errors to a level that the disc is unreadable in whole or part) prior to the occurrence of such failure. Accordingly, the source medium can be copied before it deteriorates to the level of unreadability. Such precautionary copying may be beneficial in many applications, including those where maintenance of data integrity is particularly important.

At block 543, a notification to a user is generated that informs the user that the source medium is recommended for replacement. Such notification may typically be displayed using a user interface, a monitor attached to the media server, or some other display. The notification may be further arranged to prompt the user to place a recordable medium such as recordable optical disc or removable medium into the target drive of the media server. Responsively to such prompt, the media server receives the target medium into the target drive at block 547.

At block 550, as the media server has custody of both a source and target medium, the relevant content and associated DRM licenses are copied by the media server from the source medium to the target medium. At block 555, successful copying is confirmed. By “successful” it is meant that at least the copy of the DRM license is written in a way that it can be subsequently read from the target medium without substantial errors that would corrupt the integrity of the DRM license.

At block 560, upon confirmation of successful copying, the DRM license on the source medium is overwritten or erased. At block 564, upon confirmation of successful copying, the content on the source medium is overwritten or erased. It is noted that the step shown in block 564 is optional in many applications as it may not be desirable to expend resources to erase the content from the source medium as the erasure of the associated DRM license from the source medium is commonly sufficient to render the content there usable.

At block 569, both the source medium and target medium are released from the custody of the media server. The illustrative method 500 ends at block 571.

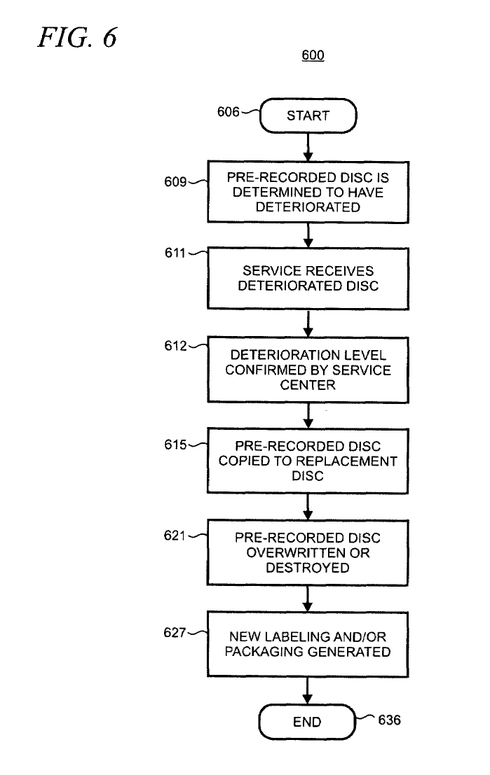

FIG. 6 is a flowchart of an illustrative method 600 for providing certified copies of pre-recorded discs from a service to consumers. By “certified” it is meant that the content copyright owner or DRM license issuer sanctions and endorses such copying. Typically, such copying by the service is performed under an appropriate legal framework and employs sufficient quality controls while ensuring adherence to all applicable DRM schemes. The illustrative method 600 starts at block 606.

At block 609, a pre-recorded disc is determined to have deteriorated to a level that indicates some action is required to save the content stored thereon before any further deterioration makes the disc unreadable in whole or part. Such determination may be performed by a media server, jukebox, or PC, for example, operated by the consumer using the above described arrangements and methods. Alternatively, the determination may be made at a service center operated by a service provider using equipment there. For example, a consumer might notice some problems with a large number of uncorrected errors on a CD or DVD (i.e., which may be manifested by skipping of music or breakup of video). The consumer would be afforded an opportunity to take the disc to the service center for diagnosis and certified replacement if appropriate.

At block 611, the service receives a disc that has been determined to have deteriorated using the present invention. At block 612, the service independently verifies the error level determination made by the consumer's media server. If so verified, then at block 615 the pre-recorded disc is copied to a replacement medium such as recordable optical disc so that both the content and associated DRM licenses are bound to the replacement medium. Once successful copying of the content and DRM licenses are confirmed, the original pre-recorded disc may be alternatively overwritten or erased, or destroyed altogether.

New labeling and packaging is optionally applied to the replacement disc by the service at block 627. The illustrative process 600 ends at block 636.

What has been described above includes illustrative examples of the jukebox disc deterioration testing. It is, of course, not possible to describe every conceivable combination of components or methodologies, but one of ordinary skill in the art may recognize that many further combinations and permutations are possible. Accordingly, the illustrative examples are intended to embrace all such alterations, modifications, and variations that fall within the spirit and scope of the appended claims.

In particular and in regard to the various functions performed by the above described methods, components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the illustrative examples herein. In this regard, it will also be recognized that the illustrative examples include a system as well as a computer-readable medium having computer-executable instructions for performing the acts and/or events of the various methods.

In addition, while a particular feature of the illustrative examples may have been disclosed with respect to only one of several implementations, such feature may be combined with one or more other features of the other implementations as may be desired and advantageous for any given or particular application or setting. Furthermore, to the extent that the terms “includes,” and “including” and variants thereof are used in either the detailed description or the claims, these terms are intended to be inclusive in a manner similar to the term “comprising.”

Other features of the invention are contained in the claims that follow.

What is claimed is:

1. A method for monitoring a condition of recordable medium, the method comprising the steps of:
reading data from the recordable medium;
applying error correction coding to the data read from the recordable media to determine a level of errors contained on the recordable medium; and
determining a level of deterioration of the recordable medium using the determined error level.

2. The method of claim 1 in which the recordable medium is selected from one of optical disc, magnetic media, semiconductor memory, Flash RAM, or magneto-optical disc.

3. The method of claim 1 including a further step of analyzing the level of deterioration over a time interval to thereby generate a failure prediction for the recordable medium.

4. The method of claim 1 including a further step of comparing the deterioration level against a replacement threshold.

5. The method of claim 4 including a further step of generating a user notification when the deterioration level reaches or exceeds the replacement threshold to thereby enable a replacement recordable medium to be created.

6. The method of claim 1 in which the error correction coding utilizes forward error correction coding.

7. The method of claim 1 in which the error correction coding utilizes Reed-Solomon coding.

8. The method of claim 4 in which the replacement threshold is optimized to a recordable medium type.

9. The method of claim 1 including a further step of periodically performing the steps of reading, applying and determining to each of a plurality of recordable media held in custody.

10. The method of claim 1 including a further step of making a copy of media content and associated DRM licenses from the recordable medium and overwriting the DRM license on the recordable medium upon completion of the copying.

11. A media server, comprising:
a media drive arranged to read data from a portable storage medium containing media content; and
a DRM system arranged for a) applying error correction coding to the data read from the recordable media to determine a level of errors contained on the recordable medium, b) determining a level of deterioration of the recordable medium using the determined error level, and c) comparing the deterioration level against a replacement threshold.

12. The media server of claim 11 further including a recordable media drive for writing data to a portable recordable medium.

13. The media server of claim 11 further including a memory for storing data read from the portable storage medium.

14. The media server of claim 13 in which the DRM system controls copying of the data read from the portable storage medium to the memory when the replacement threshold is reached or exceeded.

15. The media server of claim 13 in which the DRM system controls copying of the data read from the portable storage medium to the portable recordable medium using the recordable media drive when the replacement threshold is reached or exceeded

16. The media server of claim 12 in which the portable recordable medium is selected from one of CD-R, CD-RW, DVD+R, DVD−R, DVD-RAM, DVD+RW, DVD−RW, Blu-ray disc, writable high-definition DVD or writable optical disc.

17. The media server of claim 12 in which the portable medium is selected from one of memory card, CompactFlash card, memory stick or Secure Digital (SD) card.

18. The media server of claim 11 in which the media server is incorporated within an electronic device selected from one of jukebox, personal computer, laptop computer, CD recorder, DVD recorder, set top box, DVR, PVR, or MP3 player.

19. A computer-readable medium having computer executable instructions for performing deterioration testing of data stored on a storage medium, the instructions comprising:
monitoring health of the storage medium using a level of error correction applied to correct read errors on the storage medium;
recommending replacement of the storage medium responsively to the monitoring when a replacement threshold is met; and
destroying at least a portion of a DRM license contained on the storage medium after the storage medium is replaced.

20. The computer-readable medium of claim 18 in which the storage medium is selected from one of CD, CD-R, CD-RW, DVD, high definition DVD, HD-DVD, Blu-ray, Enhanced Versatile Disc, Holographic Versatile Disc, Versatile Multilayer disc, Forward Versatile Disc, Digital Multilayer Disc, DVD−R, DVD+R, DVD−RW, DVD+RW or DVD-RAM.

21. A method of providing a service for copying data stored on a pre-recorded medium when the pre-recorded medium has deteriorated to a replacement threshold, the method comprising the steps of:
receiving the pre-recorded medium at a service center, wherein the deterioration of the pre-recorded medium is determined by a) applying error correction coding to the data read from the recordable media to determine a level of errors contained on the recordable medium, b) determining a level of deterioration of the recordable medium using the determined error level, and c) comparing the deterioration level against a replacement threshold;
copying the data from the pre-recorded medium to a replacement medium responsively to the step of analyzing.

22. The method of claim 21 in which the deterioration determination is performed by an electronic device such as a media server remotely from the service center.

23. The method of claim 21 in which the deterioration determination is performed at the service center.

24. The method of claim 21 including a further step of generating labeling or packaging for the replacement medium that is substantially similar to labeling or packaging associated with the pre-recorded medium.

25. The method of claim 21 including a further step of overwriting or destroying the pre-recorded medium upon confirmation that the copying is successfully accomplished.
